(19) United States
(12) Patent Application Publication
(10) Pub. No.: US 2014/0368559 A1
(43) Pub. Date: Dec. 18, 2014

(54) LIQUID CRYSTAL DISPLAY DEVICE

(71) Applicant: Panasonic Liquid Crystal Display Co., Ltd., Himeji-shi (JP)

(72) Inventors: Sachiko YAMAZAKI, Osaka (JP); Yoshihisa OOISHI, Osaka (JP)

(73) Assignee: Panasonic Liquid Crystal Display Co., Ltd., Himeji-shi (JP)

(21) Appl. No.: 14/185,489

(22) Filed: Feb. 20, 2014

(30) Foreign Application Priority Data
Jun. 12, 2013 (JP) 2013-123901

(51) Int. Cl. G09G 3/36; G09G 3/34

(52) U.S. Cl. CPC G09G 3/3614; G09G 3/3406
USPC 345/691; 345/213

(57) ABSTRACT

A liquid crystal display device includes: a first image signal generating unit for acquiring an image signal and for generating a first image signal in which at least a part of the pixel drive values are reduced; a second image signal generating unit for acquiring the image signal and for generating a second image signal in which at least a part of the pixel drive values are increased; a display signal selection unit for selecting one of the first image signal and the second image signal as a display signal; and a polarity control unit for controlling a polarity of the display signal. The polarity control unit inverts the polarity of the display signal. The display signal selection unit selects the first image signal in a frame immediately before the inversion and selects the second image signal in a frame immediately after the inversion.

### CROSS-REFERENCE TO RELATED APPLICATION

The present application claims priority from Japanese application JP 2013-123901 filed on Jun. 12, 2013, the content of which is hereby incorporated by reference into this application.

### TECHNICAL FIELD

The present invention relates to a liquid crystal display device.

### BACKGROUND

A liquid crystal display device displays an image on a display surface by controlling transmission/nontransmission of light in a liquid crystal layer which is formed between a backlight unit and a color filter. The liquid crystal display device includes a plurality of pixel circuits arranged in matrix for applying an electric field to the liquid crystal layer. The transmission/nontransmission of light in the liquid crystal layer is controlled by the application of the electric field to the liquid crystal layer by the plurality of pixel circuits.

FIG. 7 illustrates an exemplary structure of a pixel circuit 300. The pixel circuit 300 has a pixel electrode 310 and a counter electrode 320 which sandwich a liquid crystal layer 330. Transmission/nontransmission of light in the liquid crystal layer 330 is controlled by an electric field between the electrodes. As the strength of the electric field becomes higher, the transmittance of the light (brightness of the displayed image) becomes higher.

Japanese Patent Application Laid-open No. 2007-17863 discloses an invention relating to a liquid crystal display device which prevents, when the ambient temperature is low, degradation of the quality of a displayed image due to the low temperature by setting the gate selection period to be longer than that at ordinary temperatures to secure the charging time.

For example, when an equivalent drive voltage is applied to the pixel electrode 310 for a period longer than a predetermined period, in order to avoid degradation of the liquid crystal material such as “screen burn-in” due to application of a constant electric field for a long time, control is exercised so that the operating frequency is reduced and the polarity of the drive voltage is cyclically inverted (low frequency drive operation). FIG. 8 is a graph showing change over time in drive voltage and brightness in low frequency drive operation according to the conventional art. The brightness has a correlation with the absolute value of the drive voltage, and thus, the brightness becomes lower at the instant of the polarity inversion, which is a cause of flicker of a displayed image.

The present invention has been made in view of the above-mentioned problem, and an object of the present invention is to provide a liquid crystal display device which reduces flicker of a displayed image.

### SUMMARY

In order to solve the above-mentioned problem, according to one embodiment of the present invention, there is provided a liquid crystal display device for displaying one image in one frame on a display unit thereof, including: a first image signal generating unit for acquiring an image signal for displaying the image, the image signal including a plurality of pixel drive values indicating drive voltages for a plurality of pixels of the display unit, and for generating a first image signal in which at least a part of the plurality of pixel drive values are reduced by a predetermined amount; a second image signal generating unit for acquiring the image signal and for generating a second image signal in which at least a part of the plurality of pixel drive values are increased by a predetermined amount; a display signal selection unit for selecting one of the first image signal and the second image signal for each frame as a display signal used for the displaying on the display unit; and a polarity control unit for controlling a polarity of the display signal. When an image based on the same image signal is displayed on the display unit for a predetermined period: the polarity control unit inverts the polarity of the display signal every plurality of frames in the predetermined period; and the display signal selection unit selects the first image signal as the display signal in a frame immediately before the inversion, and selects the second image signal as the display signal in a frame immediately after the inversion.

According to the embodiment of the present invention, the brightness of a part of an image displayed immediately before the polarity inversion is suppressed to be lower than the brightness in the image determined based on the original image signal. Thus, the reduction in brightness at the time of the polarity inversion becomes smaller to reduce flicker of the displayed image.

Further, in one embodiment of the present invention: the plurality of pixel drive values indicate a drive voltage for driving the plurality of pixels arranged in a lattice pattern in the display unit; and the at least a part of the plurality of pixel drive values indicate a drive voltage for a plurality of pixels arranged in a checkered pattern in the display unit.

According to the embodiment of the present invention, processing is carried out so that the pixel drive values of the plurality of pixels arranged in a checkered pattern are increased or reduced, and thus, brightness unevenness in the displayed image due to increase or reduction in pixel drive value is reduced.

Further, in one embodiment of the present invention: the plurality of pixel drive values indicate a drive voltage for driving the plurality of pixels arranged in a plurality of lines in the display unit; and the at least a part of the plurality of pixel drive values indicate a drive voltage for pixels included in a plurality of lines which are selected every other line from among the plurality of lines.

According to the embodiment of the present invention, processing is carried out so that the drive values of the pixels included in the plurality of lines which are selected every other line are increased or reduced, and thus, brightness unevenness in the displayed image due to increase or reduction in pixel drive value is reduced.

Further, in one embodiment of the present invention: the liquid crystal display device further includes a storage unit for storing each of the plurality of pixel drive values in correspondence with the predetermined amount of reduction and the predetermined amount of increase; the first image signal generating unit reduces each of the at least a part of the plurality of pixel drive values by the predetermined amount stored in the storage unit in correspondence with the each of the at least a part of the plurality of pixel drive values; and the second image signal generating unit increases each of the at least a part of the plurality of pixel drive values by the predetermined amount stored in the storage unit in correspondence with the each of the at least a part of the plurality of pixel drive values.

According to the embodiment of the present invention, based on the predetermined amount of reduction and the predetermined amount of increase stored in the storage unit, processing is carried out so that the pixel drive values are increased or reduced.

Further, in one embodiment of the present invention: a difference between an absolute value of reduction in brightness of the plurality of pixels when the plurality of pixel drive values are reduced by the predetermined amount and an absolute value of increase in brightness of the plurality of pixels when the plurality of pixel drive values are increased by the predetermined amount is equal to or smaller than a predetermined difference.

According to the embodiment of the present invention, the visually recognized brightness in a pixel which is driven based on a pixel drive value to be subjected to reduction or increase is equivalent to the brightness recognized by the original pixel drive value owing to effects by persistence of vision and the like.

### BRIEF DESCRIPTION OF THE DRAWINGS

FIG. 1 illustrates a structure of a liquid crystal display device according to an embodiment of the present invention.

FIG. 2 illustrates contents of a first image signal and a second image signal which are generated in the liquid crystal display device according to the embodiment of the present invention.

FIG. 3 is a graph showing change over time in drive voltage and brightness in low frequency drive operation in the liquid crystal display device according to the embodiment of the present invention.

FIG. 4 is a functional block diagram illustrating a structure for exercising image display control in the liquid crystal display device according to the embodiment of the present invention.

FIG. 5 is a graph showing a predetermined increase amount and a predetermined reduction amount stored in a brightness conversion value holding unit.

FIG. 6 illustrates contents of the first image signal and the second image signal which are generated in the liquid crystal display device according to another embodiment of the present invention.

FIG. 7 illustrates an exemplary structure of a pixel circuit.

FIG. 8 is a graph showing change over time in drive voltage and brightness in low frequency drive operation according to the conventional art.

### DETAILED DESCRIPTION

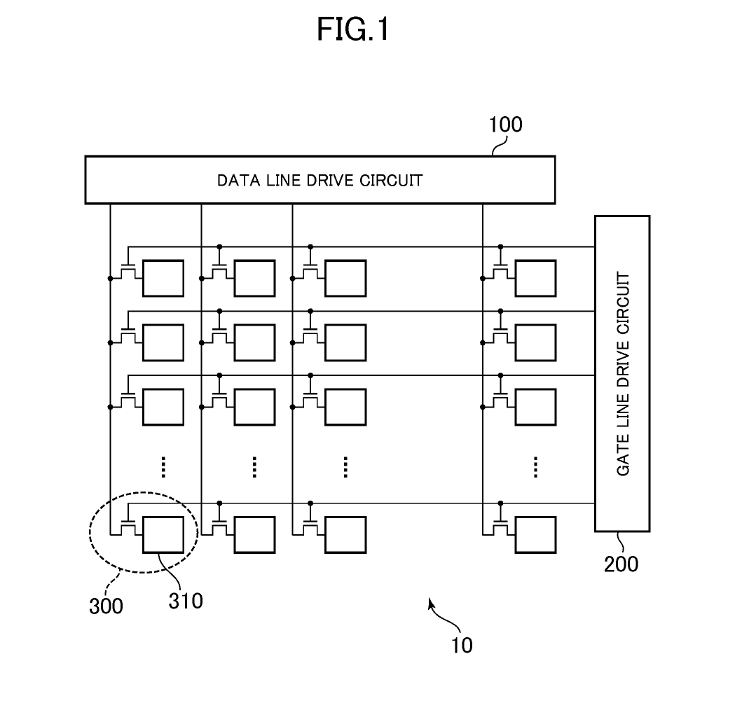

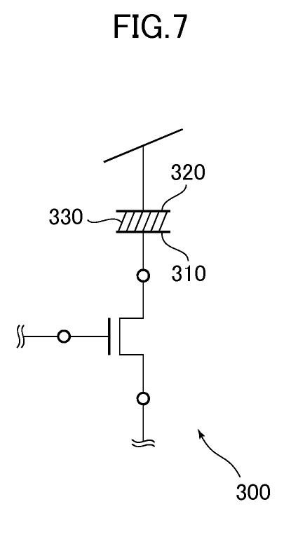

FIG. 1 illustrates a structure of a liquid crystal display device 10 according to an embodiment of the present invention. The liquid crystal display device 10 includes a data line drive circuit 100, a gate line drive circuit 200, and the pixel circuit 300 illustrated in FIG. 7. In displaying an image, the liquid crystal display device 10 acquires an image signal including pixel drive values indicating respective drive voltages for driving a plurality of pixel circuits 300, and displays one image in one frame on a display unit. When an image based on the same image signal is displayed on the display unit for a period longer than a predetermined period in the liquid crystal display device 10, a still image display signal indicating this state is input from the outside. When such still image display signal is acquired, the liquid crystal display device 10 carries out low frequency drive operation in which a frame cycle is set longer (the operating frequency is lowered) and an image based on the same image signal is continuously displayed.

When an image based on the same image signal 20 is displayed for a period longer than the predetermined period, the liquid crystal display device 10 generates a first image signal 30 in which at least a part of the pixel drive values in the image signal 20 are reduced by a predetermined amount, and a second image signal 40 in which at least a part of the pixel drive values in the image signal 20 are increased by a predetermined amount.

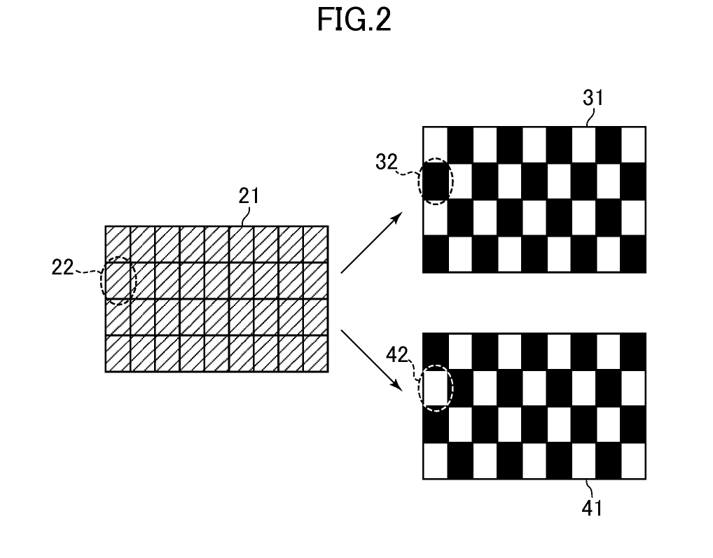

FIG. 2 illustrates contents of the first image signal 30 and the second image signal 40 which are generated in the liquid crystal display device 10 according to the embodiment of the present invention. In FIG. 2, a displayed image 21 is an exemplary displayed content when the display is based on the image signal 20, a displayed image 31 is an exemplary displayed content when the display is based on the first image signal 30, and a displayed image 41 is an exemplary displayed content when the display is based on the second image signal 40. In each of the displayed contents, a region formed by partitioning the displayed image corresponds to one pixel (pixel circuit 300). In this case, for the sake of easy understanding of the processing to be herein carried out, an example is illustrated in which the image signal 20 carries out the display in which the brightness is the same over the entire screen. The brightness of a hatched region (pixel) in the displayed image 21 in a case where the pixel drive value is increased by the predetermined amount is represented in white, while the brightness of a hatched region (pixel) in a case where the pixel drive value is reduced by the predetermined amount is represented in black. That is, with regard to a pixel (at least one pixel) corresponding to a region 22 in the displayed image 21, the pixel drive value is reduced by the predetermined amount in the first image signal 30 (region 32), while the pixel drive value is increased by the predetermined amount in the second image signal 40 (region 42).

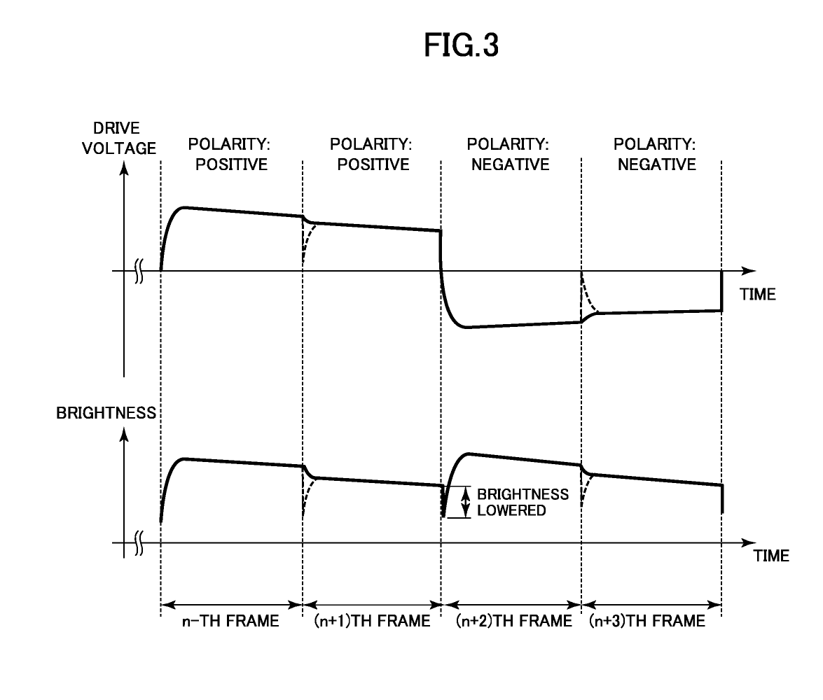

FIG. 3 is a graph showing change over time in drive voltage and brightness in the low frequency drive operation in the liquid crystal display device 10 according to the embodiment of the present invention. With regard to the drive voltage, a solid line denotes change over time when there is a storage capacitor, and a broken line denotes change over time when there is no storage capacitor. FIG. 3 shows change over time in a pixel drive value from among the plurality of pixel drive values, corresponding to a region in which the pixel drive value is reduced in the first image signal 30 and the pixel drive value is increased in the second image signal 40 (for example, the region 22 in FIG. 2). When an image based on the same image signal 20 is displayed for a period longer than the predetermined period, the liquid crystal display device 10 carries out processing so that the polarity of the drive voltage for driving the plurality of pixel circuits 300 is inversed every plurality of frames (in FIG. 3, every two frames). In the (n+1)th frame which is immediately before the inversion, the liquid crystal display device 10 displays the displayed image 31 based on the first image signal 30 in which at least a part of the pixel drive values are reduced. In this case, in the region 32 corresponding to the region 22, the pixel drive value is reduced. On the other hand, in the (n+2)th frame which is immediately after the inversion, the liquid crystal display device 10 displays the displayed image 41 based on the second image signal 40 in which at least a part of the pixel drive values in the image signal 20 are increased. In this case, in the region 42 corresponding to the region 22, the pixel drive value is increased.

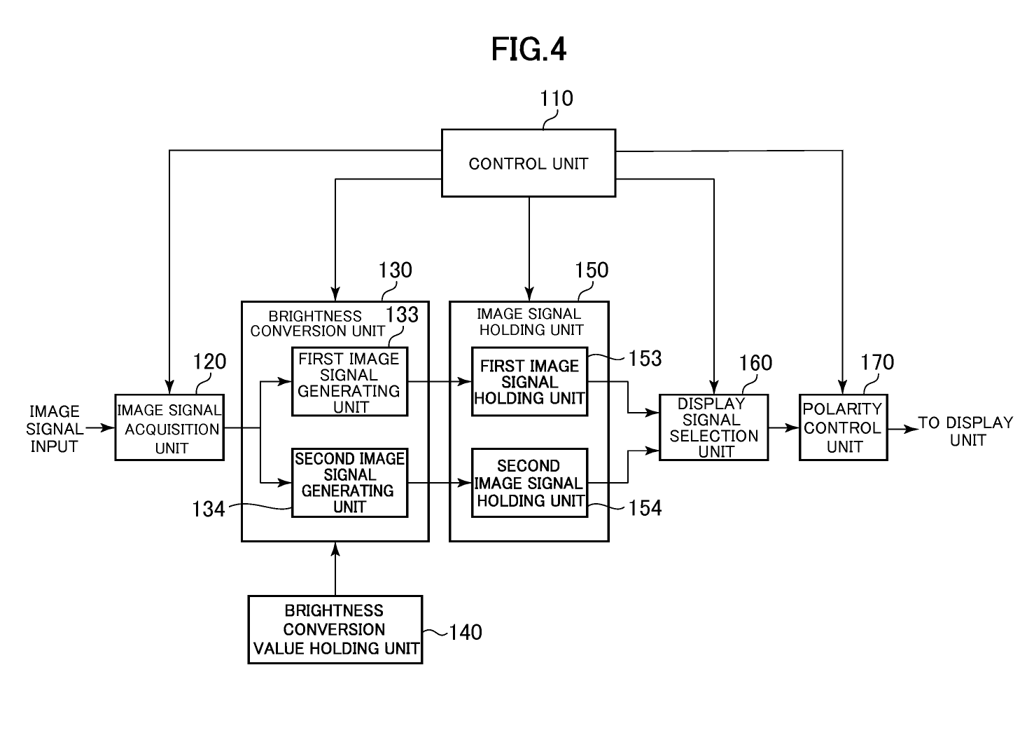

A structure for realizing the above-mentioned image display control in the liquid crystal display device 10 is described in the following. FIG. 4 is a functional block diagram illustrating the structure for exercising the image display control in the liquid crystal display device 10 according to the embodiment of the present invention. The structure is formed in, for example, the data line drive circuit 100 of FIG. 1. The liquid crystal display device 10 includes a control unit 110, an image signal acquisition unit 120, a brightness conversion unit 130, a brightness conversion value holding unit 140, an image signal holding unit 150, a display signal selection unit 160, and a polarity control unit 170. The control unit 110, the image signal acquisition unit 120, the brightness conversion unit 130, the display signal selection unit 160, and the polarity control unit 170 are realized as, for example, functions of a CPU provided in the liquid crystal display device 10, and the brightness conversion value holding unit 140 and the image signal holding unit 150 are realized by a storage element such as a memory.

The control unit 110 controls operation of the liquid crystal display device 10. When a still image display signal is input from the outside of the liquid crystal display device 10, the control unit 110 controls the polarity control unit 170 so as to invert the polarity of the display signal every plurality of frames (in this embodiment, every two frames), and controls the display signal selection unit 160 so as to acquire the first image signal with regard to a frame immediately before the polarity inversion by the polarity control unit 170 and so as to acquire the second image signal with regard to a frame immediately after the polarity inversion.

The image signal acquisition unit 120 acquires the image signal 20 indicating an image displayed in the liquid crystal display device 10. The image signal 20 includes the plurality of pixel drive values indicating the drive voltages for driving the plurality of pixel circuits 300 of FIG. 1.

The brightness conversion unit 130 generates the first image signal 30 for displaying the displayed image 31 of FIG. 2 and the second image signal 40 for displaying the displayed image 41 of FIG. 2 based on the image signal 20 acquired by the image signal acquisition unit 120. The brightness conversion unit 130 includes a first image signal generating unit 133 for generating the first image signal 30 and a second image signal generating unit 134 for generating the second image signal 40.

The first image signal generating unit 133 acquires the image signal 20 acquired by the image signal acquisition unit 120, and generates the first image signal 30 in which at least a part of the plurality of pixel drive values are reduced by the predetermined amount and the remaining pixel drive values are increased by the predetermined amount. “At least a part of the plurality of pixel drive values” in this case means pixel drive values for driving the regions (pixel circuits 300) arranged in a checkered pattern represented in black in the displayed image 31 of FIG. 2 among the regions (plurality of pixel circuits 300) arranged in matrix.

Further, the predetermined amounts of the increase and the reduction are stored in the brightness conversion value holding unit 140 in correspondence with the pixel drive value. FIG. 5 is a graph showing gamma curves of the liquid crystal display device 10. A solid curve 50 in FIG. 5 is a gamma curve with regard to the image signal before the processing is carried out by the brightness conversion unit 130 so that the pixel drive value is increased or reduced. A broken curve 51 is a gamma curve when the pixel drive value is increased by the predetermined amount. A dot-and-dash curve 52 is a gamma curve when the pixel drive value is reduced by the predetermined amount. The predetermined amounts of the reduction and the increase stored in the brightness conversion value holding unit 140 in correspondence with the same pixel drive value are values determined so that the difference between the absolute value of the reduction in brightness of a pixel driven based on the pixel drive value when the pixel drive value is reduced by the predetermined amount and the absolute value of the increase in brightness of the pixel when the pixel drive value is increased by the predetermined amount is equal to or smaller than a predetermined difference. The predetermined difference as used herein may be determined based on the brightness, for example, 10% of the brightness, or may be set to be substantially zero by determining the predetermined amounts of the reduction and the increase through close measurement of the pixel drive value and the brightness with regard to a pixel circuit in actual use.

On the other hand, the second image signal generating unit 134 acquires the image signal 20 acquired by the image signal acquisition unit 120, and generates the second image signal 40 in which at least a part of the plurality of pixel drive values are increased by the predetermined amount and the remaining pixel drive values are reduced by the predetermined amount. “At least a part of the plurality of drive values” in this case means pixel drive values for driving the regions (pixel circuits 300) arranged in a checkered pattern represented in white in the displayed image 41 of FIG. 2 among the regions (plurality of pixel circuits 300) arranged in matrix, and means the pixel drive values which are reduced in the first image signal generating unit 133. In other words, when attention is focused on a certain pixel drive value, the first image signal generating unit 133 and the second image signal generating unit 134 perform operations opposite to each other (addition and subtraction of the same value).

The first image signal 30 and the second image signal 40 which are generated by the brightness conversion unit 130 are stored in a first image signal holding unit 153 and a second image signal holding unit 154, respectively, of the image signal holding unit 150.

The display signal selection unit 160 selects and acquires one of the first image signal 30 and the second image signal 40 which are held in the image signal holding unit 150 as the display signal, based on a control signal from the control unit 110, and outputs the selected signal to the polarity control unit 170. In the low frequency drive operation, the display signal selection unit 160 selects the first image signal 30 as the display signal with regard to a frame immediately before polarity inversion and selects the second image signal 40 as the display signal with regard to a frame immediately after the polarity inversion based on control by the control unit 110.

The polarity control unit 170 controls the polarity of the display signal selected by the display signal selection unit 160 based on a control signal from the control unit 110. In the low frequency drive operation, the polarity control unit 170 inverts the polarity (from positive to negative, and from negative to positive) every predetermined plurality of frames (every two frames) based on control by the control unit 110.

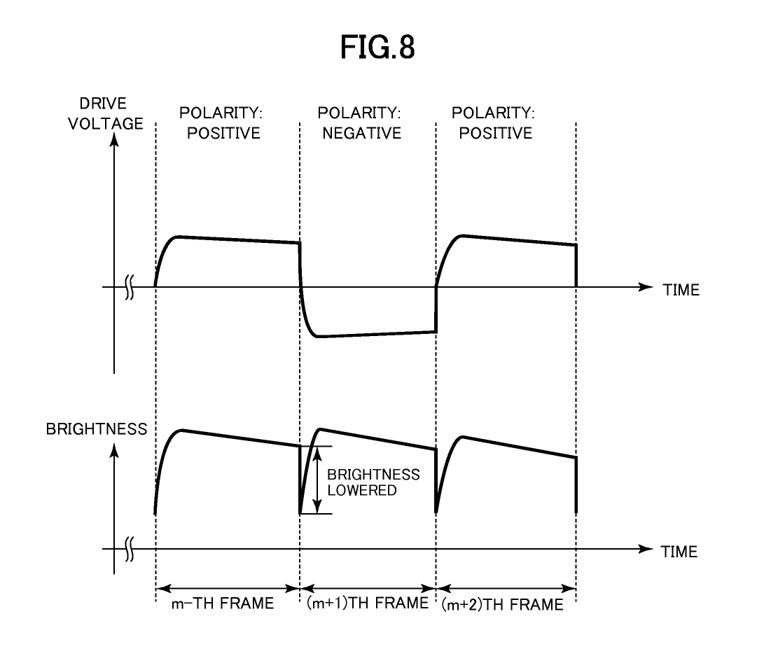

With the structure described above, the brightness of a part of an image displayed immediately before polarity inversion is suppressed to be lower than the brightness in the displayed image 21 determined based on the original image signal 20. Thus, the reduction in brightness at the time of the polarity inversion becomes smaller (see FIG. 3 and FIG. 8) to reduce flicker of the displayed image.

Further, processing is carried out so that the pixel drive values of the plurality of pixels arranged in a checkered pattern are increased or reduced, and thus, brightness unevenness in the displayed images 31 and 41 due to the increase or reduction in pixel drive value is reduced.

Still further, processing is carried out so that a pixel drive value is increased and reduced by the same amount before and after inversion, and thus, the visually recognized brightness is equivalent to the brightness recognized by the original pixel drive value owing to effects by persistence of vision and the like.

Note that, it should be understood that the present invention is not limited to the embodiment described above, and various modifications are possible which fall within the scope of the present invention.

For example, the embodiment described above shows the structure in which the pixel drive values for driving the regions (pixel circuits 300) arranged in a checkered pattern among the regions (plurality of pixel circuits 300) arranged in matrix are reduced to generate the first image signal 30 and the remaining pixel drive values are increased to generate the second image signal 40, but the present invention is not limited thereto. Other structures are possible in which at least a part of the pixel drive values are reduced before polarity inversion and are increased after the polarity inversion.

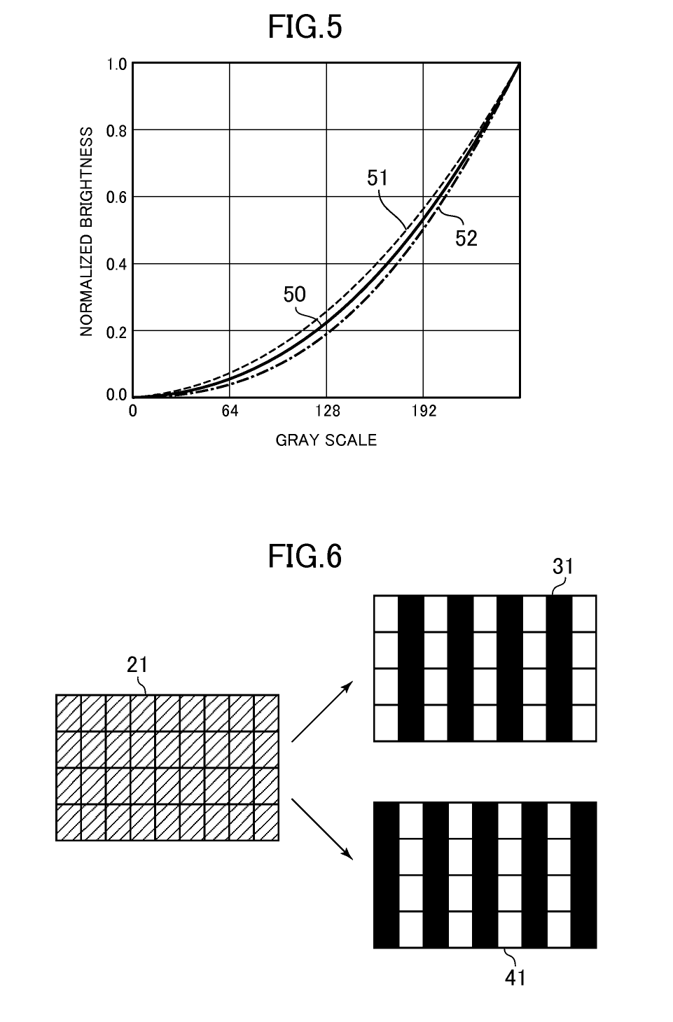

FIG. 6 illustrates contents of the first image signal 30 and the second image signal 40 which are generated in the liquid crystal display device 10 according to another embodiment of the present invention. In this embodiment, processing is carried out so as to increase or reduce the pixel drive values for driving regions included in a plurality of lines which are selected every other line from among regions arranged in a plurality of lines. Also in this embodiment, brightness unevenness in the displayed images 31 and 41 due to the increase or reduction in pixel drive value is reduced.

Further, in the case where the displayed content is not so affected even when the pixel drive values are uniformly increased or reduced, for example, the case where all the pixel drive values in the original image signal 20 are small, or, in the case where the load when the pixel drive values are individually controlled is a problem, a structure in which all the pixel drive values are reduced in the first image signal 30 and increased in the second image signal 40 may be employed.

Further, in this embodiment, the liquid crystal display device 10 which carries out low frequency drive operation is described by way of example, but the present invention is not limited thereto. The present invention is applicable also to other liquid crystal display devices which invert an electric field applied to a liquid crystal layer and further to an image display device other than a liquid crystal display device which inverts the polarity of a signal for driving a pixel.

While there have been described what are at present considered to be certain embodiments of the invention, it will be understood that various modifications may be made thereto, and it is intended that the append claims cover all such modifications as fall within the true spirit and scope of the invention.

What is claimed is:

1. A liquid crystal display device for displaying one image in one frame on a display unit thereof, comprising:
a first image signal generating unit for acquiring an image signal for displaying the image, the image signal including a plurality of pixel drive values indicating drive voltages for a plurality of pixels of the display unit, and for generating a first image signal in which at least a part of the plurality of pixel drive values are reduced by a predetermined amount;
a second image signal generating unit for acquiring the image signal and for generating a second image signal in which at least a part of the plurality of pixel drive values are increased by a predetermined amount;
a display signal selection unit for selecting one of the first image signal and the second image signal for each frame as a display signal used for the displaying on the display unit; and
a polarity control unit for controlling a polarity of the display signal,
wherein, when an image based on the same image signal is displayed on the display unit for a predetermined period:
the polarity control unit inverts the polarity of the display signal every plurality of frames in the predetermined period; and
the display signal selection unit selects the first image signal as the display signal in a frame immediately before the inversion, and selects the second image signal as the display signal in a frame immediately after the inversion.

2. The liquid crystal display device according to claim 1, wherein:
the plurality of pixel drive values indicate a drive voltage for driving the plurality of pixels arranged in a lattice pattern in the display unit; and
the at least a part of the plurality of pixel drive values indicate a drive voltage for a plurality of pixels arranged in a checkered pattern in the display unit.

3. The liquid crystal display device according to claim 1, wherein:
the plurality of pixel drive values indicate a drive voltage for driving the plurality of pixels arranged in a plurality of lines in the display unit; and
the at least a part of the plurality of pixel drive values indicate a drive voltage for pixels included in a plurality of lines which are selected every other line from among the plurality of lines.

4. The liquid crystal display device according to claim 1, further comprising a storage unit for storing each of the plurality of pixel drive values in correspondence with the predetermined amount of reduction and the predetermined amount of increase, wherein:
the first image signal generating unit reduces each of the at least a part of the plurality of pixel drive values by the predetermined amount stored in the storage unit in correspondence with the each of the at least a part of the plurality of pixel drive values; and
the second image signal generating unit increases each of the at least a part of the plurality of pixel drive values by the predetermined amount stored in the storage unit in correspondence with the each of the at least a part of the plurality of pixel drive values.

5. The liquid crystal display device according to claim 1, wherein:
a difference between an absolute value of reduction in brightness of the plurality of pixels when the plurality of pixel drive values are reduced by the predetermined amount and an absolute value of increase in brightness of the plurality of pixels when the plurality of pixel drive values are increased by the predetermined amount is equal to or smaller than a predetermined difference.
